(19) United States
(12) Patent Application Publication
(10) Pub. No.: US 2025/0078071 A1
(43) Pub. Date: Mar. 6, 2025

(54) SYSTEM AND METHOD FOR BLOCKCHAIN-BASED COMMUNICATION

(71) Applicant: T-RIZE GROUP CORPORATION, Montréal (CA)

(72) Inventors: Madani BOUKALBA, Montréal (CA); Eduardo FURTADO SA CORREA, Montréal (CA)

(21) Appl. No.: 18/819,492

(22) Filed: Aug. 29, 2024

Related U.S. Application Data
(60) Provisional application No. 63/579,982, filed on Sep. 1, 2023.

(51) Int. Cl. G06Q 20/38; G06Q 20/36

(52) U.S. Cl. CPC G06Q 20/389; G06Q 20/36

(57) ABSTRACT

A method for blockchain-based communication is provided, including requesting creation of a communication by submitting an initial transaction to a blockchain network and addressed to a smart contract deployed thereon, the transaction including a communication identifier (ID) and a list of participants. Upon receiving confirmation of the creation of the communication, the method includes transmitting a payload key to the participants prior to exchanging a first message in the communication. The method also includes submitting a transaction to the blockchain network and addressed to the smart contract, the transaction including the communication ID, a payload, and a proof indicative of the payload key, the payload being stored in the blockchain network in associated with the communication ID upon determination, by the smart contract, that the user device is in possession of the payload key based on the proof.

### CROSS REFERENCE TO RELATED APPLICATION

The present application claims the benefit of, and priority to, U.S. Provisional Patent Application No. U.S. 63/579,982 filed on Sep. 1, 2023, the disclosure of which is incorporated herein by reference in its entirety.

### TECHNICAL FIELD

The technical field generally relates to distributed ledger technology (DLT) such as blockchain technology, and more particularly to systems and methods for blockchain-based secure communication.

### BACKGROUND

Traditional communication platforms, such as centralized chat systems where a single entity is responsible maintaining the network and managing interactions between users, can create challenges regarding data privacy, security, trust in network participants and content ownership.

In parallel, Distributed Ledger Technology (DLT), and more specifically blockchain technology, has gained an increasing amount of attention and development in recent times. While the main use of blockchain technology has long been associated with value storage and exchange, one successful example of which is Bitcoin, alternative development has been made to use the power of a trustless and distributed network to exchange data, information, and more broadly anything of value that can be exchanged digitally, in transactions between two or more parties.

While blockchain technology, such as Bitcoin, had initially been touted as promoting anonymity, recent advances in blockchain research have made it clear that while public addresses used on a blockchain network are not directly associated with an entity, it is relatively easy to re-identify an entity based in its public address and publicly available information found on the internet.

Some messaging systems exist that are implemented using a blockchain network. For example, entities can include text payloads in transaction messages, and transmit the messages by submitting a transaction on the blockchain network and addressed to a public address associated with another entity. While this allows to keep an immutable history of messages exchanged between the entities, using a blockchain network also exposes them, e.g., their communication relationship.

Therefore, there is a need for a system and method of secure communication through a blockchain network adapted to at least partially alleviate the issues mentioned above.

### SUMMARY

According to an aspect, a method for blockchain-based communication is provided. The method includes: requesting, by a user device, creation of a communication by submitting an initial transaction to a blockchain network and addressed to a smart contract deployed thereon, the transaction including a communication identifier (ID) and a list of participants, the smart contract being adapted to create and manage communications; upon receiving confirmation of the creation of the communication by the smart contract, transmitting, using the user device, a payload key to the participants prior to a first exchange in the communication; and submitting, by the user device, a transaction to the blockchain network and addressed to the smart contract, the transaction including the communication ID, a payload, and a proof indicative of the payload key, the payload being stored in the blockchain network in association with the communication ID upon a determination, by the smart contract, that the user device is in possession of the payload key based on the proof.

According to an aspect, a system for blockchain-based communication is provided. The system includes: a blockchain network comprising one or more blockchain nodes having a smart contract deployed thereon, the smart contract being adapted to create and manage communications among a plurality of participants, each communication having a communication identifier (ID) and a payload key associated therewith; and a user device in operative communication with the blockchain network, the user device being adapted to submit a transaction to the blockchain network and addressed to the smart contract, the transaction including a data payload, he communication ID associated with a communication, and a proof indicative of the payload key associated with the communication, wherein the smart contract is configured to store the payload in association with the communication ID upon a determination that the user device is in possession of the payload key based on the proof.

A non-transitory computer-readable medium having instructions stored thereon which, when executed, cause a user device to perform a method including: requesting creation of a communication by submitting an initial transaction to a blockchain network and addressed to a smart contract deployed thereon, the transaction including a communication identifier (ID) and a list of participants, the smart contract being adapted to create and manage communications; upon receiving confirmation of the creation of the communication by the smart contract, transmitting a payload key to the participants prior to a first exchange in the communication; and submitting a transaction to the blockchain network and addressed to the smart contract, the transaction including the communication ID, a payload, and a proof indicative of the payload key, the payload being stored in the blockchain network in association with the communication ID upon a determination, by the smart contract, that the user device is in possession of the payload key based on the proof.

### BRIEF DESCRIPTION OF THE DRAWINGS

Other features and advantages of the present invention will be better understood upon reading the following non-restrictive description of possible implementations thereof, given for the purpose of exemplification only, with reference to the accompanying drawings in which:

FIG. 1 is a block diagram of a system for blockchain-based communication and file sharing, according to a possible embodiment.

FIG. 2 is a block diagram of an exemplary communication created using the system of FIG. 1.

FIG. 3 is a flowchart of a method for registering with the system of FIG. 1.

FIG. 4 is a flowchart of a method for creating a communication on the blockchain network of FIG. 1.

FIG. 5 is a flowchart of a method for interacting with the blockchain network of FIG. 1.

FIG. 6A is a flowchart of a process for generating a message in a communication stored in the blockchain network of FIG. 1.

FIG. 6B is a flowchart of a process for retrieving a message in a communication stored in the blockchain network of FIG. 1.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

One or more systems described herein may be implemented in computer programs executing on processing devices, each comprising at least one processor, a data storage system (including volatile and non-volatile memory and/or storage elements), at least one input device, and at least one output device. The term “processing device” encompasses computers, servers and/or specialized electronic devices which receive, process and/or transmit data. “Processing devices” are generally part of “systems” and include processing means, such as microcontrollers and/or microprocessors, CPUs or are implemented on FPGAs, as examples only. For example, and without limitation, the processing device may be a programmable logic unit, a mainframe computer, a server, a personal computer, a cloud-based program or system, a laptop, a smartphone, a wearable device, or a tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

The processor(s) are used in combination with storage medium, also referred to as “memory” or “storage means”. A storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory is of course chosen according to the desired use, whether it should retain instructions, or temporarily store, retain or update data. Steps of the proposed method are implemented as software instructions and algorithms, stored in computer memory and executed by processors.

In the following description, the term “wallet” refers to a storage medium designed to store a pair of public and private keys of a user, the pair having been generated using public-key encryption, for example. The wallet can be implemented as a software module stored on a user device used by the user, as will be described below.

The term “user”, or client, refers to an individual or an entity, such as a business, that uses the system and methods described herein. A user, i.e., an individual or an entity, can therefore exchange messages with another user, when registered with the system. For example, a communication, such as a conversation, can be created between two users, where the users are entities, each having one or more members that are participants to the communication.

The term “participant” refers to a user of the blockchain network that is part of a given communication. For example, when creating a new communication, an initiating user provides a list of participants that will be allowed to receive and send messages as part of the communication.

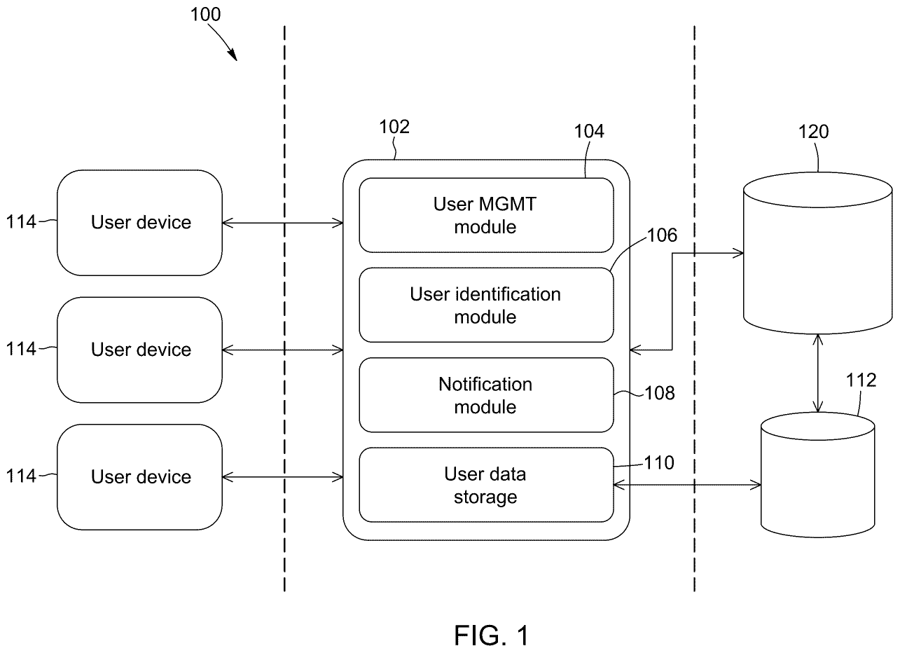

Referring to FIGS. 1-6B, the system and methods for blockchain-based communication and file sharing are particularly adapted to provide a secure environment for exchanging messages such as text messages, and files between participants of an exchange. The system and methods allow for implementing communication schemes such as conversations including one-to-one or one-to-many users, and group conversations (i.e., many-to-many). Exchanges between the participants are kept confidential from the viewpoint of non-participant users of the blockchain network, thereby advantageously improving confidentiality relative to known blockchain technologies. While the system and methods described herein use a decentralized blockchain network for communications and message history storage, a back-end server is also included, allowing for identifying, validating, or authenticating the identity of the users of the blockchain network, advantageously allowing for improving trust of participants of a communication relative to public addresses and public keys used with the blockchain network.

Generally, the system includes a back-end server, defining an off-chain component, a blockchain network, defining an on-chain component, that is deployed and maintained across a number of trusted blockchain nodes, and user devices. The back-end server is configured for authenticating and managing users of the system, such as by creating and deleting user accounts, performing identification methods to identify real users, storing shared files, and generating notifications, for example. The blockchain network, which can include a number of blockchain nodes, such as servers and/or personal computers adapted to maintain the network, is configured for exchanging messages between two or more users, for storing message history and read receipts, for example, and further configured for storing at least one upgradable smart contract. As will described in more detail below, the smart contract can be used as a proxy in the blockchain network configured for managing and storing exchanges between participants of a communication. For example, instead of using a public address of an intended participant when sending a new message, the address of the smart contract can be used, and the smart contract manages the new message. Deploying the smart contract advantageously allows for preserving anonymity of the receiving participants. The user devices are utilized by the users to interact with the blockchain network, to register an account, and with the back-end server, to send and receive message. For example, the user devices can encrypt and decrypt all sensitive data, e.g., the text of a payload or a payload file sent or received, using end-to-end encryption from a sending user device to one or more receiving user devices, meaning that only the participants can access the sensitive data, ensuring secure communication between the user devices. In some embodiments, the backend server provides a user interface that can be downloaded as a mobile application or simply used as a website page and consulted using the user device.

The system can include a blockchain network, a robust and scalable back-end server infrastructure, and a secure front-end user application/interface that allows users to interact with the blockchain network and the back-end server infrastructure while advantageously maintaining convenience for the user. The front-end application/interface can be built using a cross-platform framework, ensuring compatibility across user devices, such as smartphones and personal computers. For example, the front-end application can be a mobile or desktop application, or a web application, accessed on a user device. By anchoring communications and file exchanges to a decentralized infrastructure, the system disclosed herein provides a tool that preserves the historical records of all interactions and transactions without relying on a centralized platform. This innovative approach can enhance data integrity, transparency, availability and data ownership.

Turning to FIG. 1, system 100 for blockchain-based communication includes three sub-systems in operative communication with one another: a back-end server 102, user devices 114, and blockchain network 120. The back-end server 102, which can comprise one or more servers each having a storage medium and one or more processors, is adapted to perform general access control, user identification, notification issuance, and data storage.

The back-end server 102 includes a user management module 104, a user identification module 106, a notification module 108 and user data storage 110. The user data storage 110 is configured for storing, for each user, all user-related information that may not be required when exchanging messages and files on the blockchain network 120. The user-related information is stored on the user data storage 110 to preserve user privacy and confidentiality. The user data storage 110 is operatively connected with the user management module 104, the user identification module 106 and the notification module 108 that can consult and/or modify to user-related information. For example, the user-related information can include name, address, email addresses and/or phone number, and any document needed for identifying the user. The user data storage 110 also stores wallet-related information, such as encrypted private key and mnemonic data associated with the wallet of a user. As will be described below, storing the wallet-related information of the user can allow for providing a perceived “wallet-less” experience to the user.

The user management module 104 is configured for managing access of every user to the system 100, such as by allowing or removing user access to the blockchain network and/or to smart contract deployed to blockchain network. For example, when a given user is a participant of a communication as a member of an entity participating in the communication, user access can be revoked for the given user if the user dissociates from the entity. In some embodiments, access to the smart contract deployed on the blockchain network is only granted once user identification, or authentication, is completed, as will be described below. Therefore, the user management module 104 can prevent un-identified users from accessing the blockchain network 120 and/or the smart contract deployed thereon. Further, new users, even when identified or authenticated, can have a restricted access to the blockchain network and/or smart contract until a predetermined event occurs. For example, the user management module 104 can restrict the number of communications in which a new user can participate until a trial period is expired. Further, as will be described in more detail below, the system 100 allows for blockchain-based file sharing. The files themselves are not stored on the blockchain network 120 but rather in a file storage medium 112. The user management module 104 is therefore further configured to control user access to the file storage medium, or to a specific file, by adding or revoking user access for each user. User status and user access to communications and to files are stored in the user data storage 110.

The user identification module 106 is adapted to perform user authentication or identification when on-boarding a new user. A user using the user device 114 only exposes a public address associated with a blockchain wallet when interacting with the blockchain network 120. Therefore, identifying the user during on-boarding can reduce the risk of bad actors acting in relative anonymity. In the present embodiment, the user, along with an associated public key created during onboarding, is identified using the user identification module 106. By identification, it is meant that a user is matched with a real-life entity, e.g., a person or a company. In one embodiment, the user identification module 106 uses one of the verification concepts “Know-Your-Customer” (KYC), when the user is an individual, and “Know-Your-Business” (KYB), when the user is an entity such as a business, both well known in the art, to identify the new user. Those concepts include the user having to prove his identity through communicating, with the back-end server 102, official identification documents, for example. In other embodiments, the user management module 106 can require that the new user provide digital identifier (ID) or another verifiable credential, which is used to identify the user. The binding of a public key with a user is therefore verified by the back-end server 102 that acts as a certificate authority. Identifying a user and associating the user with a respective public key advantageously increases trust and security when exchanging messages on the blockchain network 120.

The user management module 104 can restrict or prevent any interaction between a given user and the blockchain network 120, or with the smart contract deployed on the blockchain network 120, until their identity is confirmed by the user management module 108. In some embodiments, however, a user can be allowed to receive messages transmitted using the blockchain network 120 before having finalized signing up or user identification. For example, as will be described below, compatible wallets already owned by a user can be imported in the system 100 before identification of the new user is completed. In such a case, a user device 114 sending a message through the blockchain network 120 needs to know either the receiver's blockchain address and public key, or the receiver's blockchain address and the network previously used so that the user device sending the message can automatically fetch their public key, given that they have signed at least one transaction with their private key. Optionally, if the blockchain network is not known, the public key may still be fetched if a compatible network in which the receiver has signed a transaction with their private key can be found.

The notification module 108 is configured for monitoring communications and notifying the participants of a given communication when a new message is received, i.e., when a new transaction is added to a communication stored on the blockchain network 120. In other words, for each user participating in communications, the notification module 108 monitors activity associated with each communication. In some embodiments, the notification module 108 monitors the state of the blockchain network 120 to detect new transactions. In other embodiments, a confirmation of transaction can be sent from the blockchain network 120 to the notification module via the user device 114, as will be described below. The notification can be transmitted to users via email or phone messages, for example. Therefore, the notification module 108 is configured to fetch user-related information in the user data storage 110 including email addresses and phone numbers. A level of notifications can be configured for each user, allowing to enable or to disable some or all notifications. The notification module 108 can send notifications in real time, however as blockchain transactions are subject a time to process each block, the notifications can be paced according to the block time of the blockchain network 120 (e.g., 10 seconds, but can be increased or reduced to 1 second).

The backend server 102 can also include persistent file storage 112 adapted to store files shared using the blockchain network 120. As will be explained in more detail below, the blockchain network does not store files in order to limit its size. Instead, the files are stored on the persistent file storage 112, and authenticated links to the files are created and exchanged through the blockchain network 120. Participants receiving the link can thereafter access the file storage 112 to download the file. In some embodiment, the file storage 112 includes a cloud-based storage server operatively connected with the back-end server 102.

Still referring to FIG. 1, user devices 114, utilized by the users, are operatively connected with the backend server 102 and the blockchain network 120, allowing users to register with the system, to send and receive messages from communications stored in the blockchain network 120, and to receive notifications, for example. In some embodiments, the user devices 114 include a user application/interface which can be configured to provide a perceived “blockchain-less” communication experience to the user. For example, the user application can be configured to allow a user utilizing the user device 114 to send, receive and search messages for text payloads, to search links to files or deals included in a communication, to visualize deal profiles or user profiles from communications, to tag messages, and to create new communications/subject to discuss, by interacting with the blockchain network 120. Further, the application can be configured to allow a user, through the user device 114, to add or remove participants to a communication, when there is a change in the members of an entity, to filter incoming communications so as to restrict access to a given user, and to block users if needed, for example. The user devices 114 are also configured to sign, using a private key associated with a user, transactions and read receipt, for identification of the user submitting or retrieving a transaction.

In some embodiments, the backend server 102 further includes an artificial intelligence (AI) module (not shown) adapted to process communication-related data and enhance the experience of the users. For example, the AI module can be adapted to provide insights for decision-making processes or informative and dynamic assistance to the users. The AI module can be used to simplify and/or automate document information extraction, summarization, analysis, and question generation. Further, the AI module can be expanded by training an algorithm using specialized training on curated datasets, depending on the domain of application, enabling the AI module to provide more precise support, tailored analysis, and bespoke suggestions. The AI module can be provided in a sandbox environment allowing a user to interact with the AI module without the AI module having access to the blockchain network 120, to the user data storage 110, or to the communication history of a user. The AI module can include an AI model trained using federated learning, a method known in the art, thereby allowing to train the AI model without the need to share, or centralize, data needed for training. In other embodiments, the AI module can be adapted to interact directly with the blockchain network 120.

As can be appreciated, the system can be implemented in deal-making and investment environments. In such environments, exemplary functions of the AI module can include:
Asset/deal document Analysis and summary for easy understanding;
Analysis questions suggestions, both general and document-specific;
Responses to asset or deal queries;
Key asset information and metrics generation, including financial data, market information and ESG;
Identification and emphasis of notable features associated with an asset or deal;
Detection and potential risks flagging linked to an asset or deal;
Asset and deal comparison-comparing key metrics with publicly available data;
Asset class-specific AI Assistants: Tailored AI support for different asset classes, offering specialized insights;
Deal and asset comparison: AI-driven comparisons highlighting the pros and cons of various deals and assets;
ESG evaluation: Analyzing environmental, social, and governance criteria to inform users about sustainable investment options;
Market analysis and trend summaries: In-depth market analysis and summaries of relevant trends to inform users;
Sentiment analysis for news and social media: Gauge public opinion and sentiment by analyzing news articles and social media;
Personalized recommendations: AI-curated investment suggestions based on user preferences and historical data;
Custom investment report generation: Natural language generation to create personalized and comprehensive investment reports;
Third-party data source integration: Access and analyze data from multiple sources for well-rounded insights and verification;
Automated alerts and notifications: Real-time notifications for critical events, news, or market changes to keep users informed; and
AI-generated knowledge base: Accessible in-platform repository containing AI-summarized investment concepts and terminologies.

The blockchain network 120, as mentioned above, can include a number of blockchain nodes, or validators, that are configured to maintain the network. In an embodiment, the blockchain network 120 is a permissioned, application-specific, blockchain built with the Cosmos Software Development Kit (SDK) to store the communication history. This configuration allows for energy-consumption efficiency that is achieved by having a finite number of validators and using a Proof-of-Stake (PoS) algorithm known as Tendermint consensus mechanism, conceived specifically as an energy-efficient alternative to Proof-of-Work consensus mechanisms. For example, the blockchain network can consist of a limited number of partner institutions, e.g., up to 150 validators, tasked with maintaining network security and decentralization. Unlike public blockchain networks, the permissioned blockchain network, in which each validator node of the network needs to have permission from the network to run, advantageously requires less energy consumption to maintain consensus across the validators or nodes than public blockchain networks, as the number of nodes is limited. A configurable block time, block size and gas limit can be fine-tuned to modify the energy consumption of the network based on the system's needs and performance requirements. In one embodiment, a block time of 10 seconds, a block size of 22 mb, and a gas limit of 25,000,000 is used. In some embodiments, the blockchain network can be implemented as a hybrid blockchain, corresponding to a permissioned private blockchain having public-blockchain attributes.

As mentioned above, the blockchain network 120 also includes a smart contract deployed thereon, that acts as a proxy and as a communication manager. The smart contract, which will be described further below, is configured to store messages, e.g., text payloads and file links sent by the participants, along with read receipts confirming that receiving user devices have retrieving new messages. When submitting transactions to the blockchain, either to send a new message or to send a read receipt, a user device 114 addresses the public address associated with the smart contract. The smart contract acts as a dispatcher and stores the messages based on a communication identifier (ID) included in the transaction. The smart contract is also configured to confirm that users are authorized to send messages before a message can be stored within a communication ID. For example, the smart contract verifies that a user trying to send a message to a communication, through a blockchain transaction, is a participant to the communication. If a user is not a participant, their transaction can be included in a block, but the smart contract will reject the data. Further, the smart contract is configured to allow communication administrators to revoke user access to the communication or add others to the communication through sending a transaction with a modified list of participants.

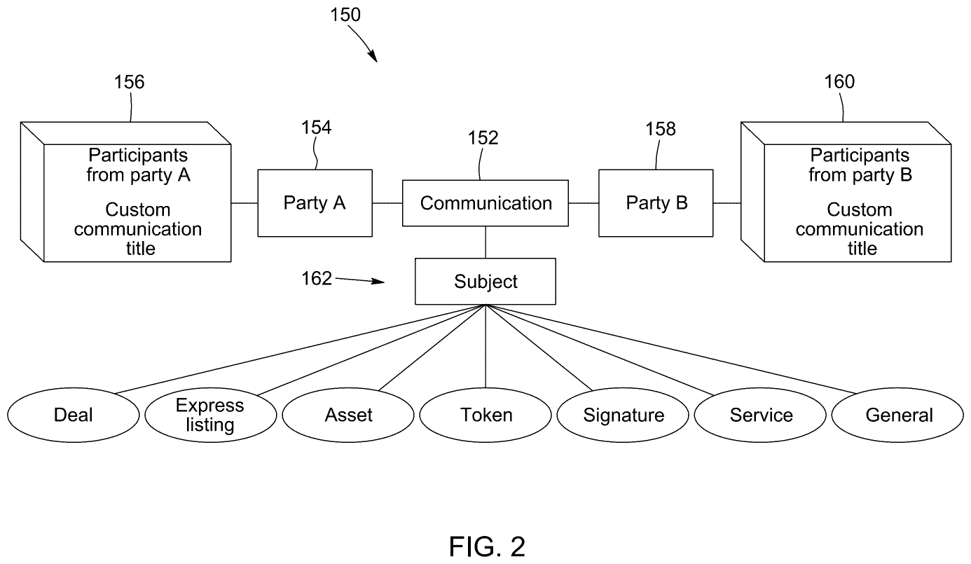

Turning to FIG. 2, an exemplary communication 150 includes Party A 154 and Party B 158 exchanging message through the blockchain network 120 using a communication identifier (ID) 152. The communication ID is used to reference any submitted message, such that the message is properly indexed on the blockchain network 120. As Party A and Party B can both correspond to entire businesses, only a subgroup of members of each party, participants 156 and 160, may have access to the communication with communication ID 152. In some embodiments, the communication can include a subject attribute 162, allowing participants to identify the communication. Some examples of subject attributes include:
Deal: Communication focused on inquiries about a deal, including due diligence, requests for additional information, financial projections, and related discussions.
Express Listing: Communication related to potential deals to gauge investor interest.
Asset: Communication focused on any real-world or digital asset, including discussions about its management, value, or transactions.
Token: Communication about the ownership, trading, or governance of digital tokens, such as discussions between traders or token holders.
Signature: Communication related to the signing of documents or files, ensuring authenticity, integrity, non-repudiation, and confidentiality of contracts, agreements and documentation.
Service: Communication regarding the terms, conditions, estimates, or any other aspects of a service provided by a service provider to a client.
General: A category for all other types of communication, including custom topics defined by users or applications. These can be anything, such as communications about the weather, event planning, customer support, invitations, etc.

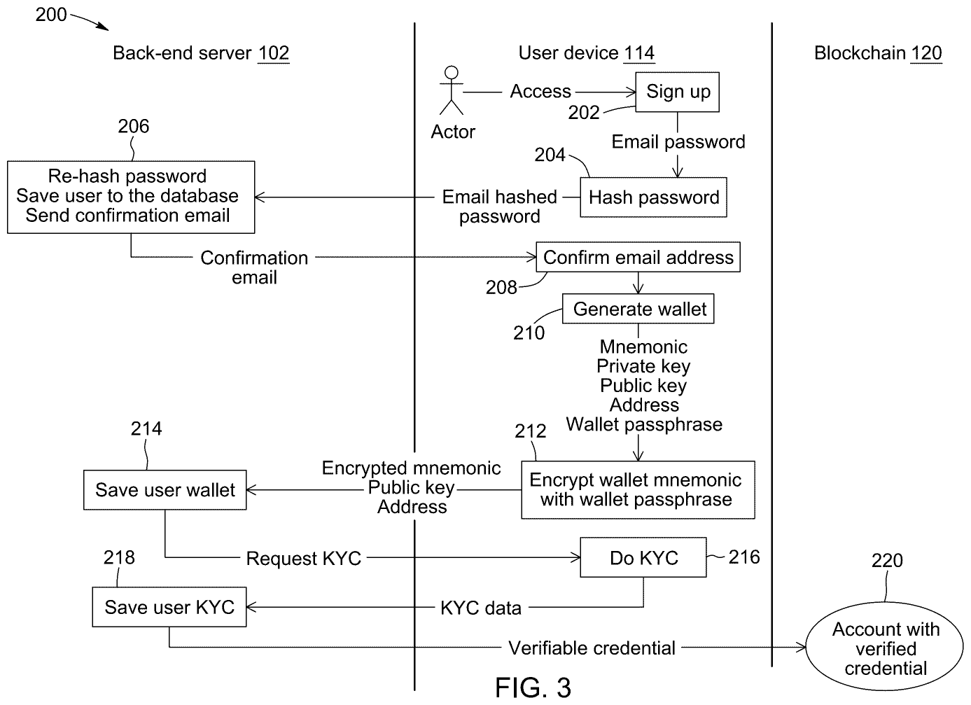

Turning to FIG. 3, method 200 for registering to the system for blockchain-based communication includes requesting creation of a new account, by a new user, or new client. Step 202 includes signing up using a user device 114. The sign-up process can include providing basic information for creating an account, such as providing a username and/or an email address and creating an account password, for example. At step 204, the password is hashed by the user device 114 such that it is secure for transfer to the back-end server 102. As will be described below, the password can be used to secure the wallet-related information. Therefore, transferring the hashed password along with encrypted wallet-related information to the back-end server 102 allows for providing a “wallet-less” experience to the user, where a user does not need to manage wallet security or maintain wallet-related information, while preventing the back-end server 102 from accessing the wallet. Once basic information for signing up is filled, method 200 includes transmitting said basic information with the hashed password to the back-end server 102 for storage as user-related information, at step 206. Storing the basic information can include creating a new entry in a user database located on the user data storage 110, for example. Step 206 can also include, prior to storing the basic information, re-hashing the password for security measures. In other words, the password is hashed both on the user device 114 and on the back-end server 102. Once the basic information is stored, step 206 includes transmitting, from the back-end server 102 to the user device 114, a confirmation email. At this point, method 200 can include a step 208 of requesting that the new user confirms the email address entered when filling the basic information. It should be understood that alternative or additional measures can be performed to confirm creation of the new account and to secure the account. For example, setting up a two-factor authentication process can be requested.

At step 210, method 200 includes generating a blockchain account, or wallet associated with the blockchain network 120 using the user device 114. In an embodiment, creating the wallet comprises generating wallet-related information including a pair of public-private keys using public-key cryptography, a mnemonic, e.g., a phrase comprising a number of words and which can be used to access the wallet, and a public address for interacting with the wallet. A wallet passphrase can be requested for protecting the wallet and associated wallet-related information. For example, the password used when creating the account can be used as the wallet passphrase, but it is appreciated that in some configurations the wallet passphrase can be different than the account password. It should be understood that artefacts generated when generating a wallet can vary according to the type of blockchain network used. In some embodiments, a new user may already have a wallet generated on an external blockchain network, for example when the user trades cryptocurrency. When the existing wallet is compatible with the blockchain network, the new user can choose to import the existing wallet instead of generating a new one at step 210. For example, a new user having a Metamask or a Keplr wallet may be allowed to import said wallet.

Once the wallet is generated, the wallet-related information is sent to the back-end server 102 for storage in the user data storage 110. As the mnemonic must be kept private, it is encrypted at step 212 with the wallet passphrase before being transmitted to the back-end server along with the wallet address and public key. At step 214, the back-end server 102 can add the wallet-related information to the user information stored in the user data storage 110. As the mnemonic is encrypted, the back-end server 102 has no usable knowledge of the wallet-related information. However, keeping the wallet-related information on the back-end server 102 allows for providing a perceived “wallet-less” experience for the user, as the wallet-related information can be provided by the back-end server 102 to the user device 114 instead of forcing the user to keep and protect their wallet-related information. It is appreciated that upon receiving wallet-related information comprising the encrypted mnemonic, the mnemonic can be decrypted by the user device 114 using the wallet passphrase, and that the private key can be derived therefrom. Alternatively, the user can opt out of the “wallet-less” experience by keeping custody of their wallet-related information, thereby being responsible for the wallet security and maintaining their wallet-related information. In that case, step 204 can be skipped. Although a particular configuration for storing wallet-related information is described, it is appreciated that other configurations are possible. For example, in an alternate embodiment, the mnemonic and private key can be encrypted with either the account password or wallet passphrase, and the encrypted mnemonic and encrypted private key can be transmitted to the back-end server 102 along with the wallet address, public key, and a hash of the account password. The back-end server 102 can then verify that the received hashed password matches the hashed password received at step 206 before adding the wallet-related information to the user information in the user data storage 110.

At step 216, the user is requested by the user identification module 106 of the back-end server 102 to perform an identification method, allowing to identify a real-life entity associated with the created account and the created wallet. Proceeding with identification of new users allows for ensuring that the public address of a given wallet is associated with its purported user, such that when addressing participants in a communication, a sending user trusts that the public addresses associated with the participants match expected real-life entities, and receiving users trust that the public address of the sending user matches an expected real-life entity. While this can reduce the decentralization of the overall system, it can help create a more secure environment. Step 216 can include the user providing, using the user device 120, documentation required by the KYC or KYB processes to identify the user.

Alternatively, other verification methods can be used, such as transmitting a digital identification (ID) or other verifiable credential (e.g., such as a verifiable credential that follows the W3C standard) of the user to the user identification module. Once the required documentation or credential is provided, step 218 includes adding the documentation or credential to the user-related information and storing said documentation or credential in the user data storage 110 of the back-end server 102. In some embodiments step 218 can further include funding the newly created or imported wallet with tokens. As will be explained in more detail below, transactions being submitted through a blockchain network include a token amount, commonly known as gas, that is used to pay for the processing of the transaction on the blockchain network. In some embodiments, the tokens are provided freely such that a user is not required to fund their wallet as part of a “faucet fund” mechanism. For example, the back-end server 102 can fund the newly created or imported wallet with one token, such that the wallet can be used by the user device 114 to interact with the blockchain network, and more particularly with the smart contract, as will be detailed below. Bypassing the need for a user to fund their wallet advantageously enhances the perceived “gasless”, or “blockchain-less” communication experience. When the token is spent by the user, the back-end server 102 can replenish the account with another token for further interactions on the blockchain network. It is appreciated that a faucet funding the wallet is not required in all embodiments. For example, in the present embodiment, the Gas Station Network (GSN) can be utilized which uses the ERC-2661 for Meta-Transactions. This can allow providing an open-source relayer instead of a faucet. This relayer can be configured to receive signed transactions from users and pay the transaction fees. In this embodiment, after the identification documentation or other verifiable credential is stored in step 218, the back-end server 102 can emit the verifiable credential to a user's blockchain account to establish an account with a verified credential 220 on the blockchain 120. In other words, the verifiable credential can be associated with the public address on the blockchain network that is associated with the user's wallet. This association can allow the user's blockchain account (i.e., as identified by the public address) to carry the verifiable credential, enabling the user to prove their identity or authorization within the blockchain network.

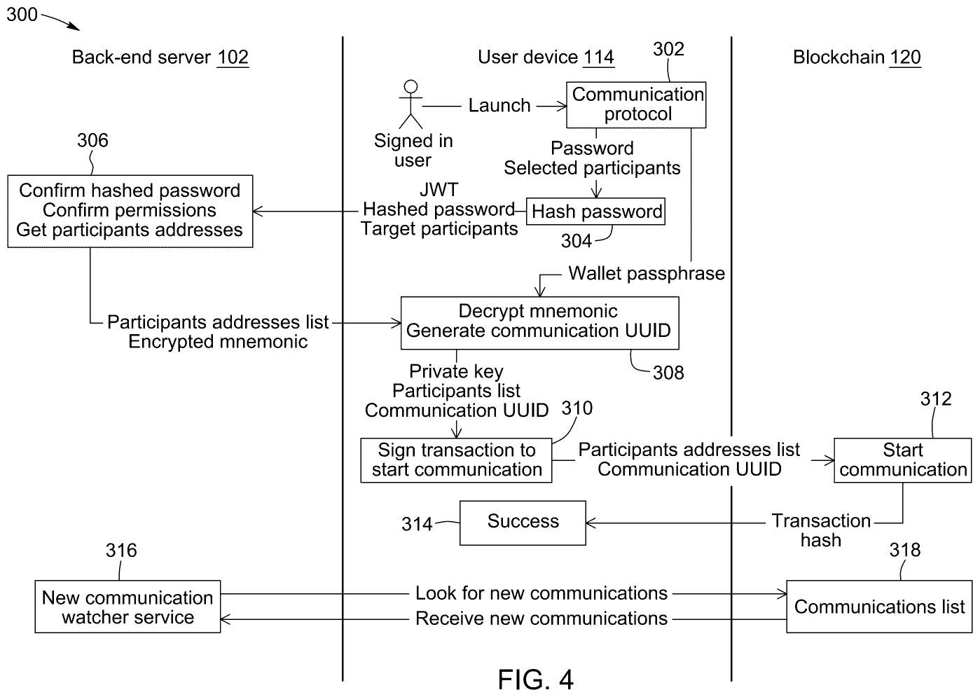

Turning to FIG. 4, method 300 for creating a communication allows creating a new communication, such as a conversation, stored on the blockchain network and with selected participants, advantageously providing a secure and immutable history of all exchanges in the communication. Method 300 is initiated, at step 302, when a user, through a user device 114, logs in to the back-end server 102 with the credentials created at step 202 (FIG. 3). The user, using user device 114, selects a list of target participants for the new communication. For example, the list of target participants can include other users and/or entities. At step 304, the list of target participants is transmitted to the back-end server 102. Further, a JSON Web Token (JWT), received from the back-end server 102 upon logging in or authenticating with the server 102 (not shown) and allowing for interacting with the server 102 without having to re-authenticate, is also transmitted to the back-end server 102. In some embodiments, a hash of the user's account password can be calculated and can also be transmitted to the back-end server 102. Even though the user is already authenticated, sending the hashed password for confirmation by the back-end server 102 prevents a third-party from using the user device 114 to perform actions with the private key or mnemonic of the wallet associated with the user, as the action will not be authorized by the back-end server 102 if the hashed password does not match the hashed password stored in the back-end server 102. The back-end server, at step 306 performs the verification of the hashed password received from the user device 114 to validate the identity of the initiating user performing the action, and verify permissions accorded to or associated with the initiating user. For example, the hashed password received is compared with the hashed password previously stored in the data user storage 110. Step 306 also includes fetching, in the database, public addresses associated with the target participants to the group communication, based on the list of target participants received from the user device 114. For example, when the list of target participants includes an entity such as a business, the back-end server can fetch the public address of a user (or users) identified as the contact person (or persons) for the entity. Once the public addresses for each participant are fetched, the back-end server 102 sends the public addresses along with the encrypted mnemonic to the user device 114. In some embodiments, the encrypted mnemonic is not sent to the user device 114, as it is stored in the JWT received by the user device 114 from the back-end server 102 when logging in or authenticating with the server 102 at step 302.

Step 308 includes obtaining, by the user device 114, the private key associated with the wallet of the user. In the present embodiment, the encrypted mnemonic is decrypted using the wallet passphrase, and the private key is derived therefrom. It is appreciated, however, that in embodiments where the encrypted private key is stored on the back-end server, the private key can be decrypted directly. Once the decrypted private key is obtained, it can subsequently be used by the user device 114 to sign transactions that will be submitted to the blockchain network. Step 308 also includes generating a communication universally unique identifier (UUID) that will be used to identify the group communication. The user device 114 further prepares and submits a transaction posted to the blockchain network. The transaction includes a data portion that contains message-related data, such as the communication UUID, a list of participants, and a payload. The payload, which can include text and file links, for example, can be empty when creating a new communication. At step 310, the transaction is signed by the user device 114 using the private key, thereby identifying the user submitting the transaction. The transaction is subsequently submitted to the blockchain network 120 and validated by a blockchain node, or validator. Once the transaction is validated, it is inserted into a block that is broadcasted across other nodes in the blockchain network. The other nodes can validate the block, and upon consensus, the block is added to the blockchain.

As mentioned above, the user can opt out of the “wallet-less” experience, in which case the back-end server 102 does not store the hashed password and encrypted wallet-related information associated with the wallet of the user. In this case, steps 304 and 306 can be skipped, and the private key and/or mnemonic stored on the user device 114, for example, is used at step 308.

The transaction signed at step 310 uses a destination address, or receiver address, that matches a public address of the smart contract deployed on the blockchain network. Therefore, once the transaction is validated, step 312 includes creating, by the smart contract, the new communication, such as a conversation. The smart contract uses the communication UUID provided in the data as a communication ID to store all messages and read receipts sent to the new communication. The smart contract maintains a list of communication IDs which corresponds to all communications created, the history of each communication is stored based on their communication IDs. Once the communication is generated, the transaction is hashed by the smart contract, and the hash to the user device 114, confirming success of the group communication at step 314. In one embodiment, the back-end server may include a communication watcher service that monitors the communications and list of communications maintained by the smart contract. Therefore, at steps 316 and 318, the back-end server 102 interacts with the blockchain network 120 through the communication watcher service to index communications that have been created by the smart contract, and to inspect every new block in the chain looking for transactions related to any of the indexed communications. As will be described below, notifications can be sent to participant of a communication when new transactions associated with a communication, such as messages, are detected by the watcher service. Once the communication is created, any participant that wants to send a message must submit a transaction to the blockchain network including a payload, the communication ID, and addressed to the smart contract.

When a new transaction is received, the smart contract validates that the sending user of the transaction is authorized to communicate in the communication. In one embodiment, prior to sending a first message to the communication, an initiating user device 114 sends a payload key as a shared secret to every participant to the communication. For example, the payload key can be sent directly to the user devices 114 associated with the participants. Alternatively, the payload key can be sent to the back-end server 102 with a list of participants of the communication. The back-end server 102 can store the encrypted payload key with the user-related information of each participant. When a transaction is submitted to the smart contract, the smart contract verifies that the sending user is authorized to interact as part of the communication by checking the signature of the transaction against the known public key of the participant. This process confirms that the sender is indeed a participant in the communication without revealing sensitive information, such as the payload key or other participant details, allowing to achieve anonymity of the participants of a communication from the point of view of non-participant users, i.e., users having access to the blockchain network 120 but that are not participants of the communication. As such, a transaction submitted to the smart contract includes a proof that the sending user, i.e., the user associated with the user device 114 submitting the transaction, has the payload key. Such a proof can be a zero knowledge proof (ZKP) generated, for example, using any suitable cryptographic technique. The transaction is signed with the sender's private key, confirming that they are a participant to the communication, without revealing the payload key or the address of the sending user. The smart contract verifies the proof and, if valid, will accept the message with the encrypted payload, to the communication ID included in the transaction. To verify the proof, the smart contract can include a verification function that can take the proof and the public inputs (e.g., the encrypted signed payload) as arguments. The function can execute a cryptographic verification algorithm to check whether the proof is valid. If the proof is valid, the smart contract can accept the message with the encrypted payload as part of the communication.

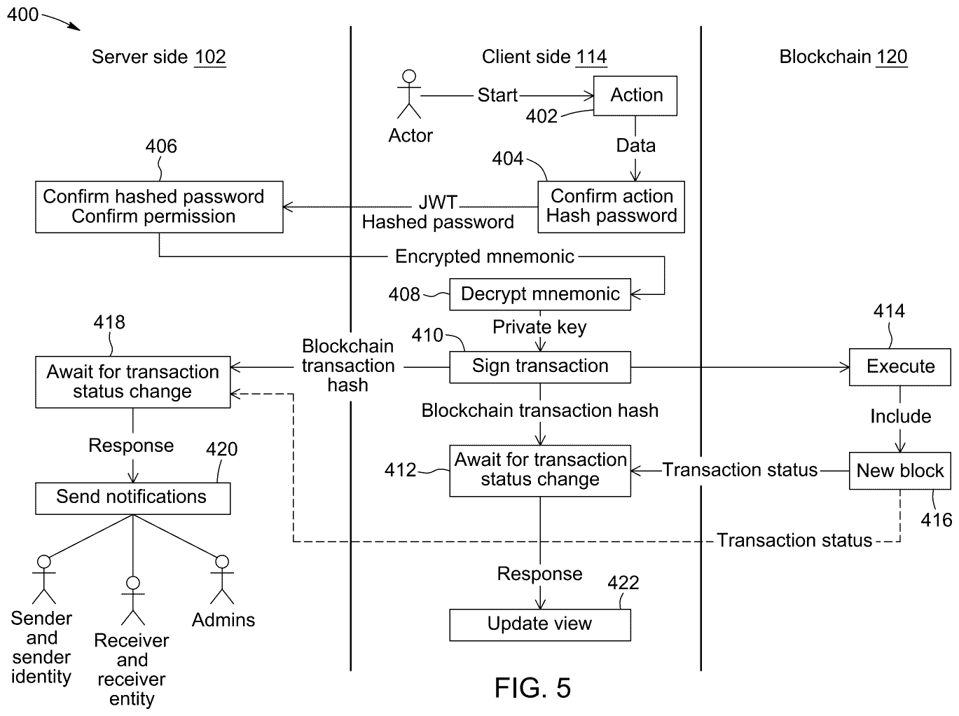

Turning to FIG. 5, a method 400 for sending a transaction from a user device 114 to a communication includes interacting with the blockchain network 120 and the back-end server 102. The transaction can be associated with an action to be performed, such as: starting a new communication, sending a package (i.e. a message) including a payload with text and/or a file, adding someone to the communication, removing someone from the communication, making a party or entity participant an admin for the party in the communication, revoking party admin status from another party admin of the communication, editing the communication subject, and setting a package as seen acting as an immutable read receipt.

At step 402, a user, or participant, using a user device 114, performs a given action, such as selecting an option to send a message with a text payload to a given communication. At step 404, the user device 114 hashes the password associated with the user account and prepares a request for confirmation that the account associated has permission to perform the action. The hashed password and the JWT is sent to the back-end server 102 and verified, at step 406, against the user-related information stored in the user data storage 110 of the back-end server 102. For example, the hashed password sent by the user device 114 is compared against the hashed password stored in the database of the back-end server 102, and permissions of the account linked with the hashed password are validated.

If the action is permitted, the back-end server 102 sends back the encrypted mnemonic stored in the user data storage 110 that is associated with the user account of the user device 114, and user device 114 decrypts the mnemonic at step 408 and derives the private key therefrom. In some embodiments, the encrypted mnemonic is already stored in the JWT, and therefore the back-end server 102 does not send the encrypted mnemonic to the user device 114. Further, as mentioned above, when a user opts out of the “wallet-less” experience, the back-end server 102 does not contain the encrypted mnemonic associated with the wallet of the user. Therefore, steps 404-408 can be skipped.

At step 410, a transaction addressed to the smart contract including a message and including the communication ID of the communication is submitted to the blockchain network 120. The sending user device 114 also generates a transaction hash, for identifying the transaction, that is sent to the back-end server 102. As mentioned above, the transaction has to be validated by a validator, or blockchain node, at step 414, which includes verifying the transaction and the signature of the sending user. Once the transaction is validated, it is included in a block, at step 416, by the validator. As the block is broadcast to the other blockchain nodes, and as a consensus must be achieved between the blockchain nodes before the block is inserted to the blockchain, the method also includes waiting for a transaction status change, e.g., a status change indicating that the transaction submitted has been validated and included in the blockchain. Step 412 includes monitoring, at the user device 114, said status change. Further, step 418 includes monitoring, at the back-end server 102, the status change of the transaction, once the transaction hash is sent by the user device 114.

Once the status of the transaction changes, a notification is displayed on the user device 114, at step 422, confirming that the message was sent to the communication. Further, as will be described below, the method includes sending notifications, at step 420, to the participants of the communication. In one embodiment, the notifications are generated and sent by the back-end server 102 based on the list of participants associated with the communication, including the sender and the sender entity, and/or the receiver and receiver entity. In some embodiments, notifications can be sent to non-participants, such as administrators of the system.

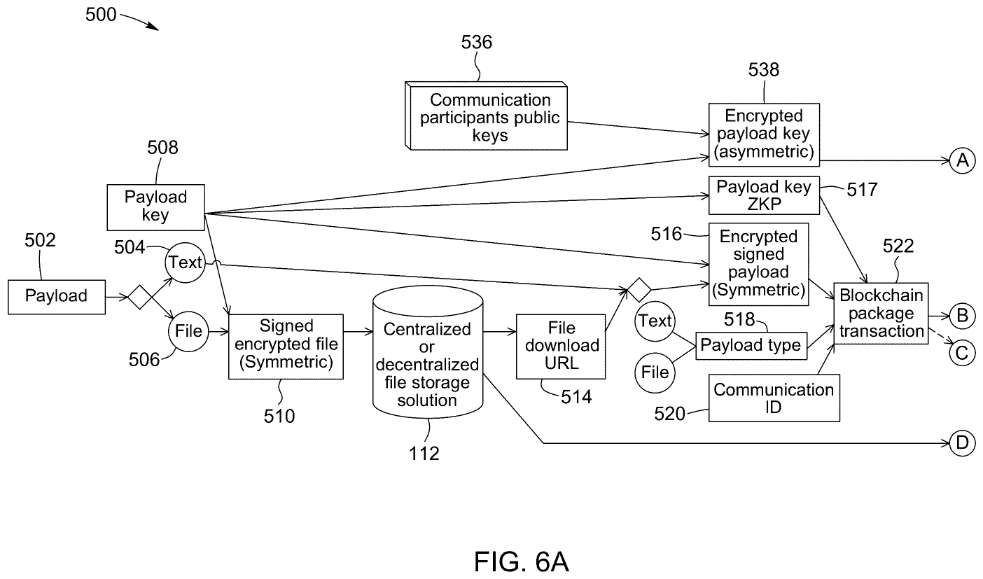

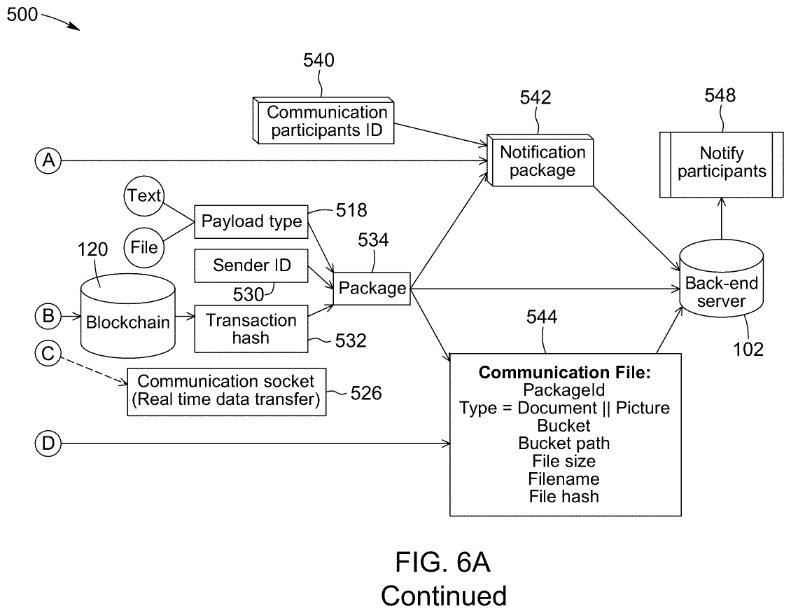

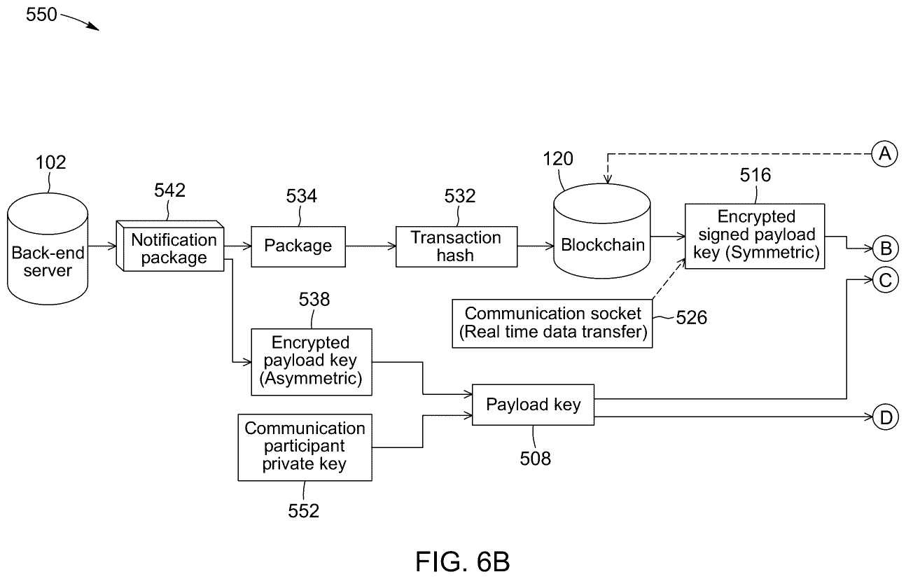

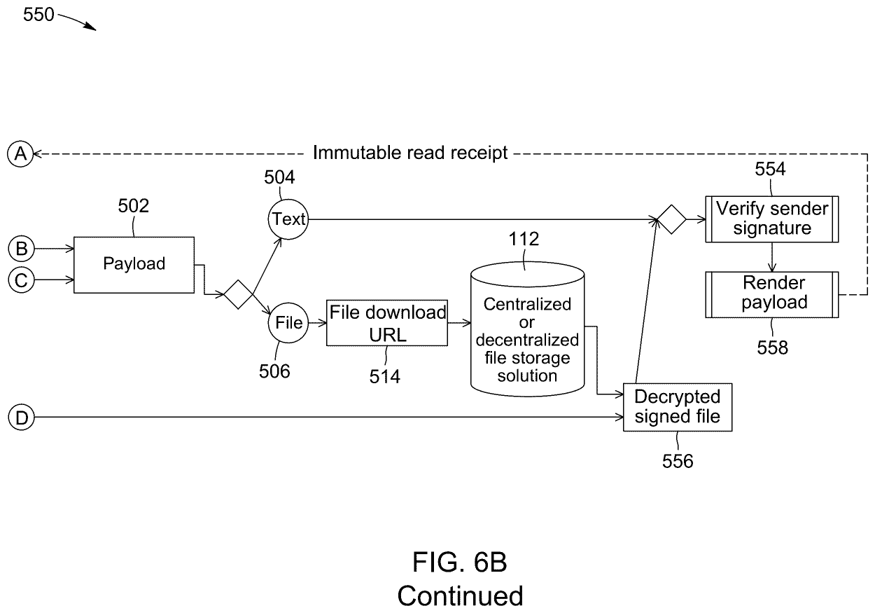

Referring now to FIG. 6A, a method 500 for sending a message as part of a communication includes generating, on the sending user device 114, a payload 502 associated with text 504, a file 506, or both, to be shared. The encrypted payload submitted to the blockchain network 120 does not contain the file itself, but rather a reference to the file 506, as will be explained below. This advantageously reduces the amount of data to be stored on the blockchain network 120. A payload key 508 (e.g., which will be used as a shared secret) is also randomly generated by the user device 114 which allows to encrypt the payload and advantageously allows for multi-party, or multi-participant, communication, as will be explained later.

When the payload includes a file 506, the payload key 508 is first used to encrypt the file, and the private key associated with the wallet of the user device 114 is used to sign the encrypted file, creating a signed and encrypted file 510. In an embodiment, the encryption is symmetric, meaning that the same payload key can encrypt and decrypt the file. The encrypted file 510 is subsequently stored into file storage medium 112. For example, the file storage medium 112 can include a local storage, such as a database within the back-end server 102. As another example, the file storage medium 112 can include remote storage, such as centralized cloud storage and/or decentralized cloud storage file storage, such as the InterPlanetary File System (IPFS), or blockchains made specifically for file storage, such as Arweave. In some embodiments, the encrypted file can be re-encrypted upon being stored, such as by using data-at-rest encryption, for further protection against unauthorized access. When storing the encrypted file on the file storage medium 112, a file download Universal Resource Locator (URL) 514 is created to allow access to the file. In some embodiments, the URL can correspond to a private download URL that is not publicly available. In some embodiments, the URL can be publicly accessible, thus allowing public and unrestricted access to the encrypted file 510.

It should be understood that the encryption of the payload occurs on the user device 114. Further, as will be detailed below, decryption also occurs on a receiving user device 114. Therefore, an end-to-end encryption (E2EE) is used, which advantageously provides protection against eavesdropping, protection against tampering or alteration, and protection against attacks against the back-end server 102, as only the user devices know the payload key.

Using the payload key 508, the text 504 and/or the download URL 514 are encrypted thereby generating an encrypted payload 516. In an embodiment, this encryption is symmetric. A blockchain package transaction 522 is then created by the sending user device 114, with the encrypted payload 516 being inserted in the data block of the package transaction 522, along with the payload type 518, e.g., text and/or file, and the communication ID 520 indicative of where the payload is to be stored on the blockchain network 120 by the smart contract. The blockchain package transaction 522 can further include a zero knowledge proof (ZKP) of the payload key 517, i.e. a proof that allows a participant to prove they know the payload key without revealing the payload key itself. As mentioned above, the transaction is then submitted to the blockchain network 120 for validation before it is immutably stored thereon. Storing the blockchain package transaction 522 on the blockchain network 120 allows for high availability of persistent data.

In parallel, or concurrently, with submitting the blockchain package transaction 522 to the blockchain network 120, the data portion of the transaction 522, or alternatively the encrypted payload 516, is sent in real time, using other channels, to the user devices 114 of the participants of the communication. Indeed, as the blockchain network 120 does not instantly process new blocks, a new message, e.g., a new text payload, will not be accessible in real time. Further, in case of blockchain network congestion, participants may find it difficult or impossible to have near real-time exchanges in a communication. Therefore, the data portion of the transaction 522 is sent via another communication channel. For example, a communication socket 526 can be opened to perform real-time communication of the data portion to the participants which are online, or which have a corresponding open communication socket 526. For example, a communication socket can be opened for each communication the user is a participant to, allowing them to instantly receive new messages posted to the different communications. The communication socket 526 can alternatively connect with the back-end server 102 that relays the data portion to the user devices of the participants. In some embodiments, the communication socket 526 is only used to send the data portions in real-time to the user devices that are online, i.e., that have a corresponding communication socket 526 opened, as data sent in this manner is not persistent and targeted to real-time delivery. In some embodiments, the communication socket is encrypted, using transport layer encryption for example. It should be understood that other means of receiving, in real-time, the data portion from the sending user device can be contemplated without departing from the present disclosure.

Once the blockchain package transaction 522 is stored on the blockchain network 120, a package 534, including the transaction hash 532, the payload type 518, and a sender ID 530 corresponding to the sending user device 114, is generated by the sending user device 114. This package 534 is to be included in a notification package 542, and to a file metadata package 544.

As the communication can include multiple participants, the method 500 uses the payload key 508 in combination with the public keys of the communication participants 536 to generate an encrypted payload key package 538. The encrypted payload key package 538 includes multiple instances of the payload key 508, each encrypted with a respective public key 536 of each participant to the communication. Therefore, each participant can use their private key, as will be described below, to decrypt the payload key 508. As public keys 536 are used to encrypt the payload key 508, and the encrypted payload key 538 can only be decrypted using a paired private key, the encryption of the encrypted payload key package 538 is asymmetric. In some embodiments, the encrypted payload key package 538 is stored in the back-end server 102 to facilitate control over who can access the messages. In other embodiments, the encrypted payload key package 538 is included in the data portion of the blockchain package transaction 522, and therefore stored on the blockchain network 120.

Still referring to FIG. 6A, the encrypted payload key package 538 is combined with package 534 and a list of communication participant IDs 540, using the sending user device 114, to generate a notification package 542 that is sent to the back-end server 102. The back-end server 102 uses the information included in the notification package 542 to notify the participants 548 that a new encrypted payload is available for retrieval, for example. When the payload includes a file, package 534 is further combined with file metadata to generate the metadata package 544, which is also stored and indexed in the back-end server 102. Indexing the metadata package 554 can provide faster access to the file information by the back-end server 102 by preventing having to query the blockchain network.

Turning to FIG. 6B, a method 550 for retrieving a payload is performed by a receiving user device 114 associated with a participant to a communication. Notification package 542 is received by the receiving user device from the back-end server 102, based on the list of participant IDs 540. Package 534 is extracted from the notification package 542 along with the encrypted payload key package 538. Using the transaction hash 532 included in package 534, the receiving user device 114 retrieves the transaction from the blockchain network 120. In some embodiments, when retrieving the transaction from the blockchain network 120, a blockchain transaction including a read receipt is submitted by the receiving user device 114, such that it can be verified that the message contained in the transaction was read. When the receiving user device 114 is online, or logged in, a communication socket 526 is opened on the receiving user device, and the encrypted payload 516 is also received in real-time through the communication socket. In order to decrypt the encrypted payload 516, the receiving user device must first decrypt the payload key 508. Therefore, the private key 552 associated with the receiving user is used by the receiving user device 114 to decrypt a corresponding instance of the encrypted payload key package 538. In some embodiments, the encrypted payload key package 538 can be stored on the blockchain network 120, and therefore the instance of the encrypted payload key can be decrypted when the transaction is retrieved on the blockchain network 120.

Once the payload key 508 is decrypted, payload 502 is obtained by decrypting the encrypted payload 516. When the payload 502 is associated with a file 506, the payload includes a file download URL 514 together with a hash of the file 506, which the receiving user device 114 uses to retrieve the file in the file storage medium 112. The file, once retrieved in the file storage medium 112, is decrypted using the payload key 508, resulting in a decrypted signed file 556. In some embodiments, the file storage medium 112 is organized using content addressable storage, which enables efficient data storage and retrieval based on file content rather than file location. The receiving user device 114 can verify the signature of the sender 554 to prove the integrity and the authenticity of the payload 502. For example, hashes of the payload 502, and/or of the file 506, and the signatures of the transaction and/or payload are used to confirm the identity of the sending user device and to confirm the integrity of the data fetched. In some embodiments, the receiving user device 114 can fetch the transaction hash on the blockchain, verify that it matches a transaction hash generated by the sending user device, and generating an integrity ticker for the receiving user. As the hashes of files are stored on the blockchain network with the signature of the sender, this ensures traceability of the origin of a potentially shared malware, discouraging parties to share malware as they will be identified. The hashes of the file can be matched against a database of known malicious files by the platform.

Once the sender signature is verified, the payload can be rendered 558, for example by displaying the text 504 and/or file 506 or representations thereof on a display of the receiving user device 114. When the payload is rendered, a blockchain transaction including a read receipt can be submitted by the receiving user device 114 to the blockchain 120, to record an indication that the message and/or file contained in the transaction was read by the communication participant.

As mentioned above, text 504 and/or file 506 are end-to-end encrypted, meaning that text 504 and/or file 506 are encrypted by the user device before proceeding with sending the message with method 500, and are decrypted only when the payload is rendered according to method 550. In other words, even though the payload is stored on the blockchain network, only the sending and receiving user devices, i.e., the participants, can read, or decrypt, the message payload. Further, while file 506 is not stored itself on the blockchain network, storing the file download URL 514, and file hash, allows receiving user devices 114 to verify the authenticity and integrity of file 506, in a decentralized manner. Indeed, by storing the hash of a file 506, a receiving user device 114 can verify that the files have not been tampered by unauthorized users or corrupted during transmission. Further, storing the hash of a file 506 allows for timestamp verification, through which a chronological record of events by the blockchain transaction included in a block with the hash is guaranteed, and further allows for aiding in the recovery of lost files by comparing the hash values of the recovered files with the original values. In one embodiment, a signature of the hash of the file 506 is stored in the blockchain network, allowing a receiving user device to confirm that the file originates from the expected sender.

As mentioned above, the system described herein uses a blockchain network that is relatively energy efficient. For example, by using a Cosmos™-based blockchain network, it is estimated, based on comparisons provided by the Cosmos™ developers, that the blockchain network deployed in the present application will consume about 0.0005 TWh per year. By comparison, this approximately corresponds to 0.0004% of Bitcoin's annual energy consumption. In other words, the proposed system for blockchain-based communication can potentially consume about 99.9996% less energy than the Bitcoin network.

The system and method for blockchain-based communication be used, outside of exchanging text messages and files, in various contexts, such as for creating and storing polls that include anonymous or non-anonymous voting, Non-disclosure Agreements (NDAs) negotiations and signature, e.g., when a group communication can contain sensitive information, exchanging proposal for peer-to-peer trades, e.g., negotiating a price and signing contracts through exchanges immutably stored on the blockchain network. Further, the system and methods described herein are particularly adapted for deal-making and negotiation domains, such as asset trading, including real estate. The system advantageously allows for securely and timely having communications with other parties, while ensuring that the communication history is immutably stored in a decentralized fashion. However, it should be understood that the system and methods can be adapted to any domain where secure communication is needed.

This inventive subject matter has been described in terms of specific embodiments, embodiments and configurations which are intended to be exemplary only. Persons of ordinary skill in the art will appreciate, having read this disclosure, that many obvious variations, modifications, and refinements may be made without departing from the inventive concept(s) presented herein. The scope of the exclusive right sought by the Applicant(s) is therefore intended to be limited solely by the appended claims.

1. A method for blockchain-based communication, comprising:
requesting, by a user device, creation of a communication by submitting an initial transaction to a blockchain network and addressed to a smart contract deployed thereon, the transaction including a communication identifier (ID) and a list of participants, the smart contract being adapted to create and manage communications;
upon receiving confirmation of the creation of the communication by the smart contract, transmitting, using the user device, a payload key to the participants prior to a first exchange in the communication; and
submitting, by the user device, a transaction to the blockchain network and addressed to the smart contract, the transaction including the communication ID, a payload, and a proof indicative of the payload key, the payload being stored in the blockchain network in association with the communication ID upon a determination, by the smart contract, that the user device is in possession of the payload key based on the proof.

2. The method of claim 1, further comprising:
encrypting, by the user device, the payload using a payload key before submitting the transaction;
generating, by the user device, a notification package including encrypted instances of the payload key, each encrypted instance of the payload key being encrypted with a unique user key associated with one of the participants; and
transmitting the notification package to the user devices associated with the participants.

3. The method of claim 2, further comprising:
retrieving, by a receiving user device associated with one of the participants, the payload stored on the blockchain network;
decrypting, by the receiving user device, an encrypted instance of the payload key associated with the receiving user device; and
decrypting the payload stored on the blockchain network using the payload key.

4. The method of claim 3, wherein the payload includes a file storage location associated with a shared file stored outside of the blockchain network, and wherein the method further comprises retrieving, by the receiving user device, the shared file stored at the file storage location included in the payload.

5. The method of claim 4, wherein the file is encrypted with the payload key, and wherein the method further comprises decrypting, by the receiving user device, the file with the payload key.

6. The method of claim 1, further comprising, concurrently to submitting the transaction to the blockchain network, transmitting, by the user device, the payload to the user devices via a channel external to the blockchain network.

7. The method of claim 1, further comprises identifying, by a back-end server, a new user prior to allowing interactions between a user device associated with the new user and the smart contract.

8. A system for blockchain-based communication, the system comprising:
a blockchain network comprising one or more blockchain nodes having a smart contract deployed thereon, the smart contract being adapted to create and manage communications among a plurality of participants, each communication having a communication identifier (ID) and a payload key associated therewith; and
a user device in operative communication with the blockchain network, the user device being adapted to submit a transaction to the blockchain network and addressed to the smart contract, the transaction including a data payload, he communication ID associated with a communication, and a proof indicative of the payload key associated with the communication,
wherein the smart contract is configured to store the payload in association with the communication ID upon a determination that the user device is in possession of the payload key based on the proof.

9. The system of claim 8, wherein the payload key associated with the communication is provided to all participants of the communication.

10. The system of claim 8, wherein concurrently to submitting the transaction to the blockchain network, the user device is configured to send the payload to user devices associated with one or more of the participants via a channel external to the blockchain network, such that at least part of the payload is received in real time by the one or more participants.

11. The system of claim 8, wherein the user device is configured to encrypt the payload using a payload key prior to submitting the transaction.

12. The system of claim 11, further comprising a back-end server in operative communication with user devices associated with the participants, wherein the user device is further configured to generate a notification package when submitting the transaction, the notification package including the payload key, transaction-related information for identifying the transaction on the blockchain network, and participant-related information for identifying the participants to the communication, the notification package being transmitted to the back-end server.

13. The system of claim 12, wherein the notification package includes instances of the payload key encrypted with unique user keys, each instance of the payload key being encrypted with one unique user key such that each user device associated with one of the participants is adapted to decrypt a respective instance of the payload key.

14. The system of claim 12, wherein the back-end server is configured to generate a notification when a new notification package is received, the notification being transmitted to the user devices associated with the participants of the communication associated with the new notification package.

15. The system of claim 12, wherein the user device is configured to decrypt the payload key upon receiving the notification and to retrieve the payload stored in the blockchain network based on the transaction-related information.

16. The system of claim 8, wherein when the payload includes a file storage location, and wherein the user device is configured to download a file located at the file location.

17. The system of claim 8, further comprising a back-end server in operative communication with user devices associated with the participants, wherein the back-end server is configured to verify an identity of a new user before access to the smart contract is granted to the new user.

18. A non-transitory computer-readable medium having instructions stored thereon which, when executed, cause a user device to perform a method comprising:
requesting creation of a communication by submitting an initial transaction to a blockchain network and addressed to a smart contract deployed thereon, the transaction including a communication identifier (ID) and a list of participants, the smart contract being adapted to create and manage communications;
upon receiving confirmation of the creation of the communication by the smart contract, transmitting a payload key to the participants prior to a first exchange in the communication; and
submitting a transaction to the blockchain network and addressed to the smart contract, the transaction including the communication ID, a payload, and a proof indicative of the payload key, the payload being stored in the blockchain network in association with the communication ID upon a determination, by the smart contract, that the user device is in possession of the payload key based on the proof.
